(19) United States
(12) Patent Application Publication
(10) Pub. No.: US 2026/0153663 A1
(43) Pub. Date: Jun. 4, 2026

(54) ILLUMINATION DEVICE AND DISPLAY DEVICE

(71) Applicant: Magnolia White Corporation, Tokyo (JP)

(72) Inventors: Shinichi KOMURA, Tokyo (JP); Hiroaki KIJIMA, Tokyo (JP); Koichi OKUDA, Tokyo (JP); Jin HIROSAWA, Tokyo (JP)

(73) Assignee: Magnolia White Corporation, Tokyo (JP)

(21) Appl. No.: 19/405,407

(22) Filed: Dec. 2, 2025

(30) Foreign Application Priority Data
Dec. 3, 2024 (JP) 2024-210556

(51) Int. Cl. F21V 8/00; G02B 27/01

(52) U.S. Cl. CPC G02B 6/0028; G02B 6/002; G02B 6/0031; G02B 6/0035; G02B 6/0076; G02B 27/0172; G02B 2027/0178

(57) ABSTRACT

According to an embodiment, in an illumination device, a first light guide has a cross-sectional shape of a trapezoid in which a lower base thereof is longer than an upper base, a second light guide includes a third light guide and a first protruding portion. The third light guide has a cross-sectional shape of a trapezoid in which a lower base thereof is longer than an upper base. The first protruding portion has a cross-sectional shape of a trapezoid in which an upper base thereof is longer than a lower base. The fourth edge of the second light guide and the sixth edge of the first protruding portion are formed to be integrated to constitute a seventh edge. The seventh edge is inclined relative to a thickness direction.

### CROSS-REFERENCE TO RELATED APPLICATION

This application is based upon and claims the benefit of priority from Japanese Patent Application No. 2024-210556, filed Dec. 3, 2024, the entire contents of which are incorporated herein by reference.

### FIELD

Embodiments described herein relate generally to an illumination device and a display device.

### BACKGROUND

In a laser backlight that uses an element emitting laser light as a light source, a backlight which can uniformize the in-plane luminance distribution has been developed.

### BRIEF DESCRIPTION OF THE DRAWINGS

FIG. 1 is a perspective view showing an example of an appearance of a display device according to an embodiment.

FIG. 2 is a perspective view schematically showing a configuration of a display panel provided in a display device according to an embodiment.

FIG. 3 is a cross-sectional view schematically showing a configuration of the display device.

FIG. 4 is a cross-sectional view schematically showing a configuration of the display device.

FIG. 5 is a cross-sectional view showing an example of a more detailed configuration of the illumination device.

FIG. 6 is a cross-sectional view showing another configuration example of the illumination device in Embodiment 1.

FIG. 7 is a cross-sectional view showing an example of an illumination device in Embodiment 1.

FIG. 8 is a partially enlarged view of FIG. 7.

FIG. 9 is a cross-sectional view schematically showing a configuration example of the display device in Embodiment 2.

FIG. 10 is a cross-sectional view showing an example of the display device in Embodiment 2.

FIG. 11 is a cross-sectional view schematically showing a configuration example of the display device in Embodiment 2.

FIG. 12 is a cross-sectional view showing an example of an illumination device in embodiment 3.

FIG. 13 is a cross-sectional view schematically showing a configuration example of the display device in Embodiment 3.

FIG. 14 is a cross-sectional view showing an example of the display device in Embodiment 3.

FIG. 15 is a cross-sectional view schematically showing a configuration example of the display device in Embodiment 3.

### DETAILED DESCRIPTION

In general, according to one embodiment, an illumination device comprises
a first light guide having a first edge and a second edge provided on an opposite side to the first edge, a first surface and a second surface provided on an opposite side to the first surface;
a second light guide provided on the first light guide;
a light source element provided to face the second light guide;
a reflector provided to face the first surface of the first light guide; and
an optical sheet provided on the second light guide,
wherein
the first light guide has a cross-sectional shape of a first trapezoid in which a lower base thereof is longer than an upper base,
the second light guide includes a third light guide and a first protruding portion formed to be integrated with each other,
the third light guide has a cross-sectional shape of a second trapezoid in which a lower base thereof is longer than an upper base,
the first protruding portion has a cross-sectional shape of a third trapezoid in which an upper base thereof is longer than a lower base,
the third light guide has a third edge and a fourth edge provided on an opposite side to the third edge, a third surface and a fourth surface provided on an opposite side to the third surface,
the first protruding portion has a fifth edge parallel to the second edge and a sixth edge provided on an opposite side to the fifth edge,
the second surface of the first light guide and the third surface of the third light guide face each other,
a plurality of second protruding portions are provided in a first region of the first surface of the first light guide,
the fourth edge of the second light guide and the sixth edge of the first protruding portion are formed to be integrated to constitute a seventh edge,
the seventh edge is inclined relative to a thickness direction, and
a reflecting member is provided in contact with the seventh edge.

Further, according to another embodiment, an illumination device comprises
a first light guide having a first edge and a second edge provided on an opposite side to the first edge, a first surface and a second surface provided on an opposite side to the first surface;
a second light guide provided on the first light guide;
a light source element provided to face the second light guide; and
a reflector provided to face the first surface of the first light guide,
wherein
the first light guide has a cross-sectional shape of a first trapezoid in which a lower base thereof is longer than an upper base,
the second light guide includes a third light guide and a first protruding portion formed to be integrated with each other,
the third light guide has a cross-sectional shape of a second trapezoid in which a lower base thereof is longer than an upper base,
the third light guide has a third surface and a fourth surface provided on an opposite side to the third surface, a third edge and a fourth edge provided on an opposite side to the third edge,
the first protruding portion includes a second protruding portion and a third protruding portion formed to be integrated with each other,
the second protruding portion has a cross-sectional shape of a third trapezoid in which an upper base thereof is longer than a lower base,
the second protruding portion has a fifth edge parallel to the third and a sixth edge provided on an opposite side to the fifth edge,
the third protruding portion has a cross-sectional shape of a triangle,
the third protruding portion has a seventh edge parallel to the second edge and an eighth edge distinct from the seventh edge,
the sixth edge of the second protruding portion and the eighth edge of the third protruding portion are formed to be integrated to constitute a ninth edge,
the light source element is provided to face the third edge of the third light guide,
the second surface of the first light guide and the third surface of the third light guide face each other,
a plurality of fourth projecting portions are provided in a first region of the first surface of the first light guide, and
the fourth edge and the ninth edge form a U-shaped edge.

Furthermore, according to still another embodiment, an illumination device comprises
a light guide including a first light guide and a second light guide formed to be integrated with each other;
a light source element provided to face the second light guide; and
a reflector provided to face the first light guide,
wherein
the first light guide has a first edge and a second edge provided on an opposite side to the first edge, and a first surface and a second surface provided on an opposite side to the first surface,
the first light guide has a cross-sectional shape of a first trapezoid in which a lower base thereof is longer than an upper base,
the second light guide is provided on the first light guide,
the second light guide includes a third light guide and a first protruding portion formed to be integrated with each other,
the third light guide has a cross-sectional shape of a second trapezoid in which a lower base thereof is longer than an upper base,
the third light guide has a third surface and a fourth surface provided on an opposite side to the third surface, and a third edge and a fourth edge provided on an opposite side to the third edge,
the first protruding portion includes a second protruding portion and a third protruding portion formed to be integrated with each other,
the second protruding portion has a cross-sectional shape of a third trapezoid in which an upper base thereof is longer than a lower base,
the second protruding portion has a fifth edge parallel to the third and a sixth edge provided on an opposite side to the fifth edge,
the third protruding portion has a cross-sectional shape of a triangle,
the third protruding portion has a seventh edge parallel to the second edge and an eighth edge distinct from the seventh edge,
the sixth edge of the second protruding portion and the eighth edge of the third protruding portion are formed to be integrated to constitute a ninth edge,
the light source element is provided to face the third edge of the third light guide,
the reflector is provided to face the first surface of the first light guide,
the second surface of the first light guide and the third surface of the third light guide face each other,
a plurality of fourth projecting portions are provided in a first region of the first surface of the first light guide, and
the fourth edge and the ninth edge form a U-shaped edge.

An object of this embodiment is to provide an illumination device with improved light extraction efficiency. With such an illumination device provided, another object is to provide a display device with improved brightness.

Embodiments will be described hereinafter with reference to the accompanying drawings. Note that the disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

The embodiments described herein are not general ones, but rather embodiments that illustrate the same or corresponding special technical features of the invention. The following is a detailed description of one embodiment of a display device with reference to the drawings.

In this embodiment, a first direction X, a second direction Y and a third direction Z are orthogonal to each other, but may intersect at an angle other than 90 degrees. The direction toward the tip of the arrow in the third direction Z is designated as up or above, and the direction opposite to the direction toward the tip of the arrow in the third direction Z is designated as down or below. Note that the first direction X, the second direction Y and the third direction Z may as well be referred to as an X direction, a Y direction and a Z direction, respectively.

With such expressions as “the second member above the first member” and “the second member below the first member”, the second member may be in contact with the first member or may be located away from the first member. In the latter case, a third member may be interposed between the first member and the second member. On the other hand, with such expressions as “the second member on the first member” and “the second member beneath the first member”, the second member is in contact with the first member.

Further, it is assumed that there is an observation position to observe the optical control element on a tip side of the arrow in the third direction Z. Here, viewing from this observation position toward the X-Y plane defined by the first direction X and the second direction Y is referred to as plan view. Viewing a cross-section of the display device in the X-Z plane defined by the first direction X and the third direction Z or in the Y-Z plane defined by the second direction Y and the third direction z is referred to as cross-sectional view.

### EMBODIMENT

FIG. 1 is a perspective view showing an example of the appearance of a display device according to an embodiment. In the embodiment, the display device may be a head-mounted display (HMD) that is used while being worn on the user's head. Such a display device is used to provide, for example, virtual reality (VR) for a user who has the display device mounted on his/her head.

As shown in FIG. 1, the display device DSP comprises a display panel PNLh for the left eye and a display panel PNLm for the right eye. The display panel PNLh and the display panel PNLm may as well in some cases referred to as the first display panel and the second display panel, respectively. The display panel PNLh and the display panel PNLm are independent display panels.

The display panel PNLh and the display panel PNLm are disposed so that they are located in front of the left eye and right eye of the user USR, respectively, when the display device DSP is worn on the user's head. In the embodiment, it is assumed that the display panels PNLh and PNLm are liquid crystal display panels having a liquid crystal layer.

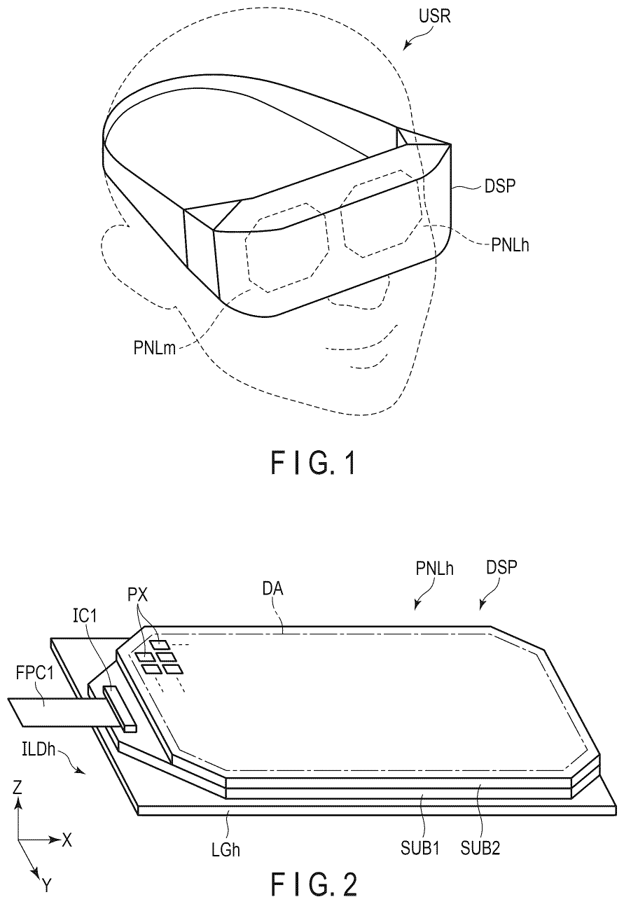

FIG. 2 is a perspective view schematically showing a configuration of the display panel provided in the embodiment. Here, the configuration of the display panel PNLh will be mainly described.

The display panel PNLh shown in FIG. 2 comprises a first substrate SUB1 and a second substrate SUB2 facing the first substrate SUB1. Further, the display panel PNLh includes a display area DA that displays images. Furthermore, the display panel PNLh comprises a plurality of pixels PX arranged in a matrix pattern in the display area DA, for example.

On the other hand, the display panel PNLh comprises a drive IC chip IC1 that drives the display panel PNLh and a flexible circuit board FPC1 that transmits control signals to the display panel PNLh. The flexible circuit board FPC1 is connected to a control module (host computer) that controls the operation of the display device DSP.

In the example shown in FIG. 2, the first substrate SUB1 and the second substrate SUB2 each have long sides along the first direction X and short sides along the second direction Y. The first substrate SUB1 and the second substrate SUB2 each have an octagonal shape in a plan view. This shape can also be described as a rectangular shape in which corners thereof are cut off. The shape of the display panel PNLh in plan as view is octagonal.

However, the shape of the display panel PNLh is not limited to this, and it suffices if the shape is any polygonal. It suffices if the display panel is of any shape that prevents it from coming into contact with the nose of the user USR, and it suffices if it has such a shape that corners that come close to the nose of the user USR are cut off.

In the example shown in FIG. 2, the shape of the display panel PNLh is discussed. The display panel PNLm has a shape that is line-symmetric with respect to the display panel PNLh in relation to the second direction Y as an axis. Except for the point that it has a shape that is line-symmetric with respect to the second direction Y, the configuration of the display panel PNLm is similar to that of the display panel PNLh.

Below the display panel PNLh, an illumination device ILDh is provided. In the example shown in FIG. 2, only the light guide LGh of the illumination device ILDh is shown. The light guide LGh has a rectangular shape extending along the first direction X and the second direction Y.

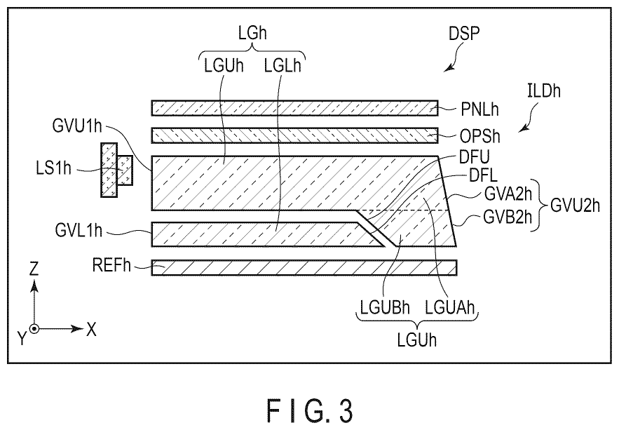

FIG. 3 is a cross-sectional view schematically showing an example of the display device. The display device DSP shown in FIG. 3 comprises an illumination device ILDh and a display panel PNLh. The illumination device ILDh comprises a reflector REFh, a light guide LGLh, a light guide LGUh, an optical sheet OPSh, and a light source element LS1h. The reflector REFh, the light guide LGLh, the light guide LGUh, and the optical sheet OPSh are stacked in this order.

The light guide LGLh and light guide LGUh constitute the light guide LGh shown in FIG. 2. On the illumination device ILDh, a display panel PNLh is provided.

In FIG. 3, of edges of the light guide LGUh, one located on the left side of the page is designated as an edge GVU1h, and one on the right side of the page is designated as an edge GVU2h. Of the edges of the light guide LGLh, one located on the left side of the page is designated as an edge GV1h, and one on the right side of the page is designated as an edge DFL. In other words, the edge DFL is disposed on the opposite side to the edge GVL1h on the page.

The light guide LGLh has a trapezoidal cross-sectional shape in which the lower base is longer than the upper base. The left leg of the trapezoidal shape, namely the edge GVL1h, extends along the third direction Z. The right leg of the trapezoidal shape, namely, the edge DFL, extends at an angle relative to the third direction Z.

The light guide LGUh includes a light guide LGUAh and a protruding portion LGUBh. The light guide LGUAh and the protruding portion LGUBh are formed to be integrated with each other, thus constituting the light guide LGUh. The light guide LGUAh has a trapezoidal cross-sectional shape in which the lower base is longer than the upper base. The left leg of the trapezoidal shape, namely, the edge GVU1h, extends along the third direction Z. The right leg of the trapezoidal shape, namely, the edge GVA2H, extends at an angle relative to the third direction Z. In other words, the edge GVA2H is disposed on the opposite side to the edge GVU1h on the page. In Embodiment 1, the third direction Z is referred to as a thickness direction as well.

The protruding portion LGUBh has a trapezoidal cross-sectional shape in which the upper base is longer than the lower base. The left leg of the protruding portion LGUBh, namely, the edge DFU, extends at an angle relative to the third direction Z. The edge DFU is illustrated as a right-downward diagonal line.

The right leg of the protruding portion LGUBh, namely the edge GVB2h, extends at an angle to the third direction Z. The edge GVB2h is illustrated as a right-downward diagonal line. In other words, the edge GVB2h is disposed on the opposite side to the edge DFU on the page.

The edge DFU of the protruding portion LGUBh and the edge DFL of the light guide LGLh are approximately parallel to each other. The edge GVB2h of the protruding portion LGUBh and the edge GVA2h of the light guide LGUAh are formed to be integrated with each other, constituting the edge GVU2h. The edge GVU2h is illustrated as a right-downward diagonal line.

Light source element LS1h is disposed to face the edge GVU1h of the light guide LGUh. Light emitted from the light source element LS1h is incident on the edge GVU1h of the light guide LGUh.

The light source element LS1h may employ a laser light source (laser diode), such as a semiconductor laser which emits laser light. This laser light may be diverged light having a spread centered on the irradiation direction, or it may be polarized laser light.

Note that although the edges GVU1h and GVL1h are referred to as edges, they are actually surfaces parallel to the Y-Z plane. The edges GVU2h, DFU, and DFL are actually surfaces inclined at an angle to the Y-Z plane. The angle of inclination of the edge GVU2h and the angles of inclination of the edge DFU and the edge DFL are different in FIG. 3, but they may be the same.

On each of the main surfaces of the reflector REFh, the light guide LGLh, the light guide LGUh, and the optical sheet OPSh, a plurality of protruding portions (which may as well be referred to as prisms) are provided.

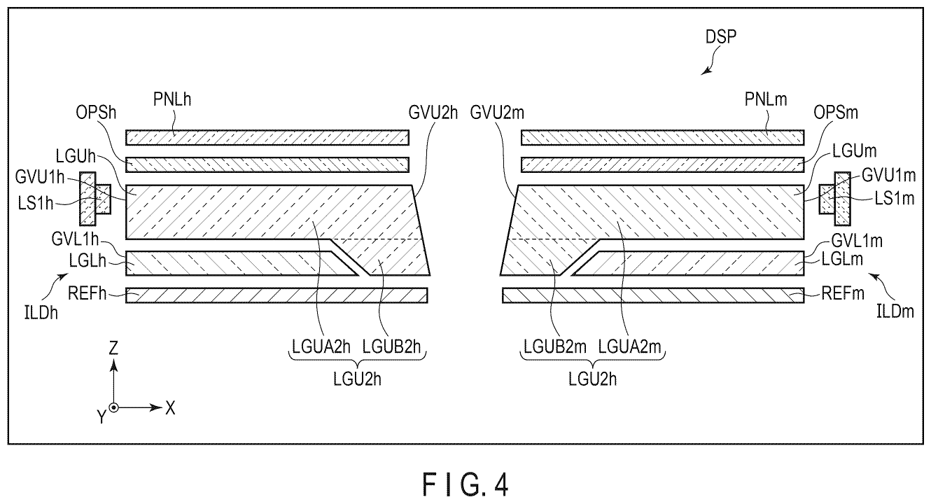

FIG. 4 is a cross-sectional view schematically showing a configuration of the display device. The display device DSP shown in FIG. 4 comprises an illumination device ILDh for the left eye, a display panel PNLh for the left eye, an illumination device ILDm for the right eye, and a display panel PNLm for the right eye. The display panel PNLh is mounted on the illumination device ILDh, and the display panel PNLm is mounted on the illumination device ILDm.

The illumination device ILDh and the display panel PNLh have respective configurations similar to those of the illumination device ILDh and the display panel PNLh shown in FIG. 3. The illumination device ILDm and the display panel PNLm are placed symmetrically with respect to the Y-Z plane relative to the illumination device ILDh and display panel PNLh.

The illumination device ILDm comprises a reflector REFm, a light guide LGLm, a light guide LGUm, an optical sheet OPSm, and a light source element LS1m. The reflector REFm, the light guide LGLm, the light guide LGUm, and the optical sheet OPSm are stacked in this order.

The light guide LGUm has an edge GVU1m and an edge GVU2m. The edge GVU1m is located on the right side of the page and faces the light source element LS1m. The edge GVU2m is located on the left side of the page and faces the edge GVU2h of the light guide LGUh.

The light guide LGLm has an edge GVL1m and an edge GVL2m. The edge GVL1m is located on the right side of the page and aligned with the edge GVU1m of the light guide LGUm along the third direction Z. The edge GVL2m is located on the left side of the page upper and faces the edge GVL2h of the light guide LGUh.

The cross-sectional shape of each of the light guide LGLh and light guide LGLm is a trapezoidal shape in which the lower base is longer than the upper base. The light guide LGUh, as described above, has a light guide LGUAh having a trapezoidal cross-sectional shape and a protruding portion LGUBh having a trapezoidal shape. The light guide LGUm, in a similar manner to the light guide LGUh, has a light guide LGUAm having a trapezoidal cross-sectional shape and a protruding portion LGUBm having a trapezoidal shape.

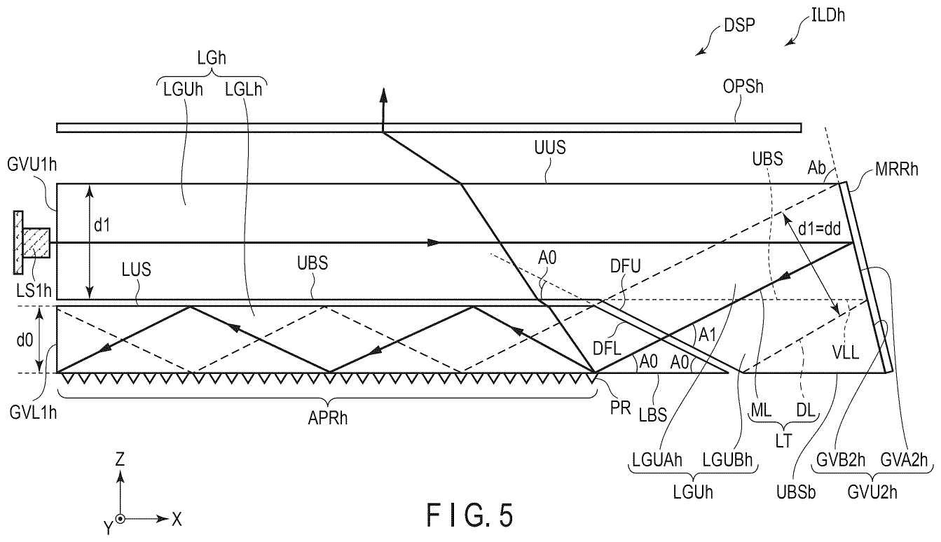

FIG. 5 is a cross-sectional view showing an example of a more detailed configuration of the illumination device. The illumination device ILDh shown in FIG. 5 includes, in addition to the configuration of the illumination device shown in FIG. 3, a mirror, which is a reflecting member, provided to be in contact with the edge GVU2h and the edge GVL2h.

Of the main surfaces of the light guide LGUAh, the one facing the optical sheet OPSh is designated as a surface UUS. The main surface on the opposite side to the surface UUS, which is the bottom surface of the light guide LGUAh, is designated as a surface UBS. The bottom surface of the protruding portion LGUBh is designated as a surface UBSb. The upper surface of the protruding portion LGUBh is designated as a surface VLL. The left edge of the protruding portion LGUBh is designated as an edge DFU, as described above. In the region where the light guide LGUAh and the protruding portion LGUBh are formed to be integrated with each other, the surface UBS and surface VLL are in contact with each other. Or, it can be said that, in the region where the light guide LGUAh and the protruding portion LGUBh are formed to be integrated, the surface UBS and surface VLL are the same as each other.

The main surface of the light guide LGLh, which faces the surface UBS of the light guide LGUAh, is designated as a surface LUS. The main surface on the opposite side to the surface LUS is designated as a surface LBS. The right edge of the light guide LGLh is designated as an edge DFL, as described above.

In a region APRh of a part of the surface LBS of the light guide LGLh, a plurality of protruding portions PR (which may as well be referred to as prisms or grooves) are provided.

The thickness of the light guide LGLh (the length along the third direction Z) is designated as a thickness do. The thickness of the light guide LGUAh is designated as a thickness d1.

Light LT emitted from the light source element LS1h contains a main light ray ML and diverged light DL (diffusion light DL). The light LT emitted from the light source element LS1h enters the light guide LGUAh from the edge GVU1h. The width dd of the diverged light DL is equal to the thickness d1 of the light guide LGUAh. The light LT having entered the light guide LGUAh from the edge GVU1h propagates along the first direction X.

The light LT having reached the edge GVA2h is reflected downward by the mirror MRRh. The thus reflected light LT proceeds from the light guide LGUAh of the light guide LGUh to the protruding portion LGUBh. Further, the light LT exits from the edge DFU of the protruding portion LGUBh and enters the interior of the light guide LGLh from the edge DFL of the light guide LGLh.

The light LT having entered the light guide LGLh propagates in the opposite direction to the first direction X within the light guide LGLh, while repeating total reflection between the surface LBS and the surface LUS. At this time, the condition that the width dd of the diverged light DL is equal to the thickness d1 (dd=d1) is maintained.

When the light LT propagating in the direction opposite to the first direction X within the light guide LGLh enters a protruding portion PR, it is reflected at the protruding portion PR and emitted upward. The light is then emitted from the surface LUS into the light guide LGUh, and further emitted from the surface UUS of the light guide LGUh into the optical sheet OPSh. The light LT emitted into the optical sheet OPSh is further emitted upward along the third direction Z by a protruding portion provided on the optical sheet OPSh.

When the angle A0 at which the main light ray ML of the light LT reflected by the mirror MRRh enters the surface LBS of the light guide LGLh is 26.5° (A0=26.5°), the light LT containing the diverged light DL is applied onto the region APRh uniformly. When applied onto the region APRh uniformly, all of the light LT is emitted upward. That is, the extraction efficiency of the light LT is increased.

To satisfy the condition that the angle A0 is 26.5° (A0=26.5°), it is preferable that the thickness d1 of the light guide LGUh is 1.8 times or more the thickness do of the light guide LGLh (d1≥1.8 d0). But note here that the refractive index n of both the light guide LGLh and the light guide LGUh is assumed to be 1.4 or greater but less than or equal to 1.6 (1.4≤n≤1.6). For such a material, a transparent resin material can be listed as an example.

Further, under the above-described conditions, it is assumed that the angle formed by the surface LBS and the edge DFL of the light guide LGLh is the angle A0 as well. In this case, the angle A1 formed between the main light ray ML and the edge DFU should preferably be 48° or greater (A1≥48°). For example, when the angle A0 is 26.5° (A0=26.5°), the angle A1 is 53° (A1=53°). If the angle A1 is less than 48°, the light LT having entered the light guide LGLh undergoes total internal reflection repeatedly and propagates through the light guide LGLh without striking the protruding portion PR. When not striking the protruding portion PR, the light LT is not emitted upward, and thus the extraction efficiency is decreased.

Further, to satisfy the above-described conditions, the angle Ab formed by the surface UUS and the edge GVU2h should preferably be 76.75° (Ab=76.75°). Here, it can be said that the angle Ab is the angle formed by the mirror MRRh relative to the first direction X.

According to this embodiment, it is possible to obtain an illumination device with improved light extraction efficiency. With such an illumination device thus comprised, a display device with enhanced brightness can be obtained.

### <Configuration Example 1 of Embodiment 1>

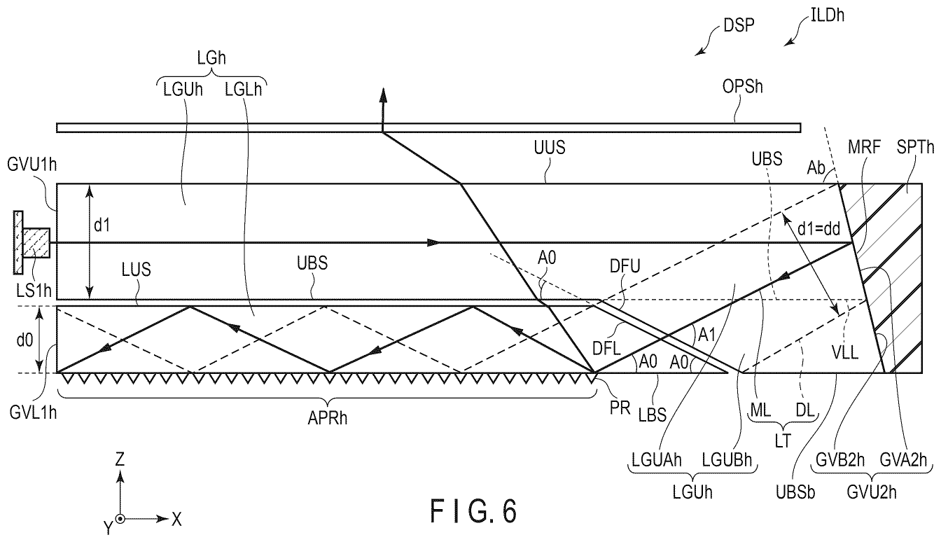

FIG. 6 is a cross-sectional view showing another configuration example of the illumination device in Embodiment 1. The configuration shown in FIG. 6 is different from the configuration shown in FIG. 5 in that it includes a support member having subjected to mirror-polishing.

The illumination device ILDh shown in FIG. 6 comprises a support member SPTh having a mirror-finished surface MRF as the reflecting member, in place of the mirror MRRh shown in FIG. 5. The support member SPTh may be formed from a synthetic resin, such as plastic. The mirror-finished surface MRF may be formed, for example, by vapor deposition of a metal, such as aluminum.

In this configuration example 1 as well, advantageous effects similar to those of Embodiment 1 can be achieved.

### Embodiment 2

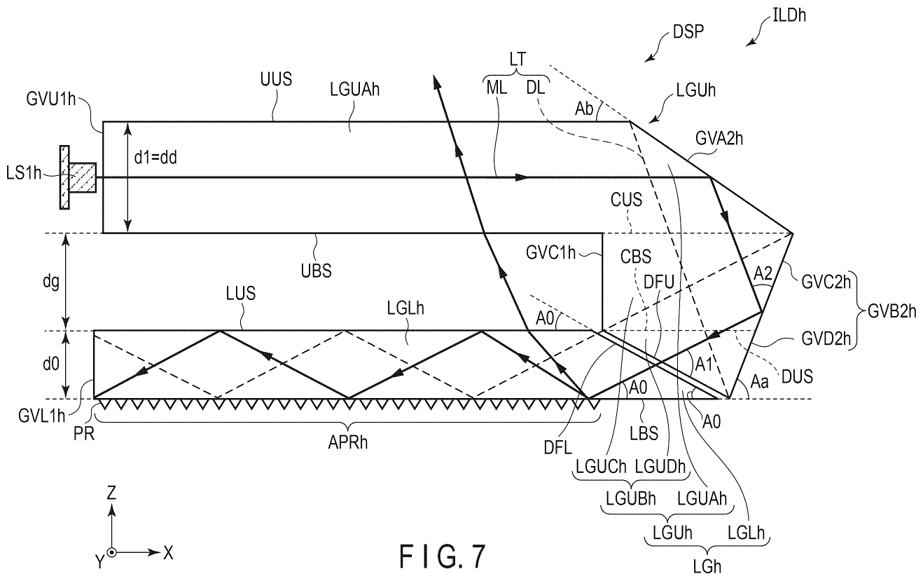

FIG. 7 is a cross-sectional view showing an example of an illumination device in Embodiment 2. The configuration shown in FIG. 7 is different as compared to the configuration shown in FIG. 5 in that it performs total internal reflection at an edge of the light guide without using a mirror.

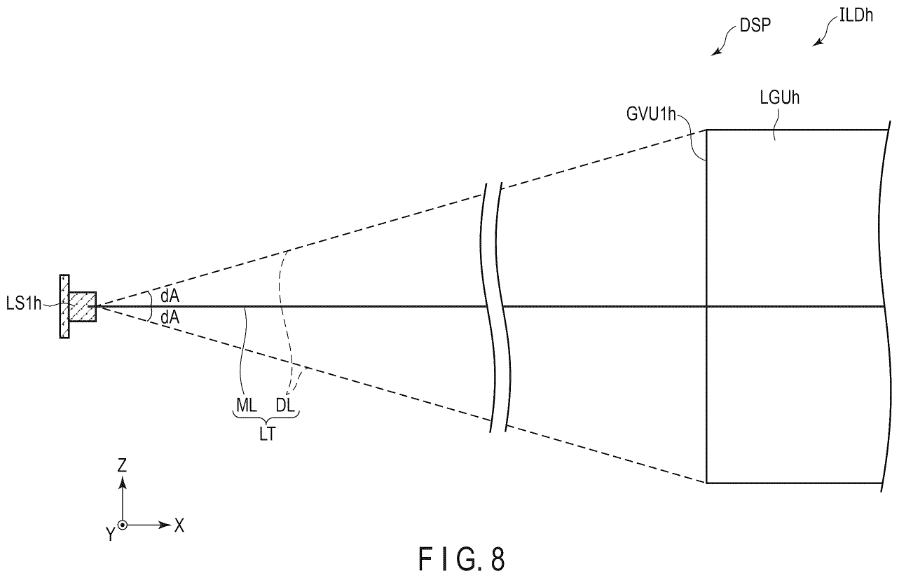

FIG. 8 is a partially enlarged view of FIG. 7. FIG. 8 shows a main light ray ML and diverged light DL between a light source element LS1h and an edge GVU1h of a light guide LGUh. Of the light LT emitted from the light source element LS1h, the main light ray ML propagates along the first direction X.

The divergence angle dA (diffusion angle dA) represents an angle indicating an inclination of the diverged light DL relative to the main light ray ML. The diverged light DL spreads clockwise and counterclockwise around the first direction X, which is the direction of propagation of the main light ray ML, at the divergence angle dA.

Returning to FIG. 7, the illumination device ILDh will be described in further detail. The illumination device ILDh includes a light guide LGh having an approximately U-shaped configuration, or a shape of an alphabet U laid on its side. The light guide LGh includes a light guide LGUh and a light guide LGLh. The light guide LGUh includes a light guide LGUAh and a protruding portion LGUBh, which are formed to be integrated therewith. The protruding portion LGUBh further includes a protruding portion LGUCh and a protruding portion LGUDh, which are formed to be integrated therewith.

The light guide LGLh shown in FIG. 7 has a configuration similar to that of the light guide LGLh shown in FIG. 5. For the description of the light guide LGLh shown in FIG. 7, the description of FIG. 5 should be referred to, and here, the description is omitted.

The cross-sectional shape of the light guide LGUAh is a trapezoidal shape in which the lower base thereof is longer than the upper base. The cross-sectional shape of the protruding portion LGUCh is a trapezoidal shape in which the upper base thereof is longer than the lower base. The cross-sectional shape of the protruding portion LGUDh is triangular. The cross-sectional shape of the light guide LGLh is a trapezoidal shape in which the upper base is longer than the lower base.

The cross-sectional shape of the light guide LGUAh, which is trapezoidal as described above, has an upper base shorter than the lower base and a lower base longer than the upper base. The surface corresponding to the upper base is designated as a surface UUS, and the surface corresponding to the lower base is designated as a surface UBS.

The left leg of the trapezoid, which is the cross-sectional shape of the light guide LGUAh, is designated as an edge GVU1h. The right leg of the trapezoid, which is the cross-sectional shape of the light guide LGUAh, is designated as an edge GVA2h. The edge GVA2h extends at an angle relative to the third direction Z. The edge GVA2h is a hypotenuse sloping downward to the right relative to the page. The edge GVA2h is disposed on the opposite side to the edge GVU1h on the page.

The trapezoid of the protruding portion LGUch, which is the cross-sectional shape as described above, has an upper base longer than the lower base and a lower base shorter than the upper base. The surface corresponding to the upper base is designated as a surface CUS, and the surface corresponding to the lower base is designated as a surface CBS. In the region where the light guide LGUAh and the protruding portion LGUCh are formed to be integrated, the surface UBS and the surface CUS are in contact with each other. Or, in the region where the light guide LGUAh and the protruding portion LGUCh are formed to be integrated, the surface UBS and the surface CUS can as well be said to be the same as each other.

The left leg of the trapezoid, which is the cross-sectional shape of the protruding portion LGUch, is designated as an edge GVC1h. The edge GVC1h extends along the third direction Z. The edge GVC1h can as well be said to be parallel to the edge GVU1h. The right leg of the trapezoid, which is the cross-sectional shape of the protruding portion LGUCh, is designated as an edge GVC2h. The edge GVC2h extends at an angle relative to the third direction Z.

The cross-sectional shape of the protruding portion LGUDh, which is a triangle, has three edges. The surface DUS corresponding to one of these three edges, is in contact with the surface CBS. Or, the surface DUS and the surface CBS can as well be said to be the same as each other.

The edge DFU, another one of the three edges of the protruding portion LGUDh, extends at an angle relative to the third direction Z. The edge DFU is approximately parallel to the edge DFL of the light guide LGLh.

The edge GVD2h, which is still another of the three edges of the protruding portion LGUDh, is formed to be integrated with the edge GVC2h and thus constitutes the edge GVB2h. The edge GVC2h, the edge GVD2h, and the edge GVB2h are oblique edges sloping downward to the left relative to the page.

The edge GVA2h and the edge GVB2h constitute a U-shaped edge. In other words, it can be said that the edge GVA2h and the edge GVB2h form a shape similar to a mountain shape turned sideways. Or, it can be said that the edge GVA2h and the edge GVB2h constitute a shape similar to a greater-than sign of “>”.

The edge GVL1h of the light guide LGLh is referred to as an edge, but is actually a plane parallel to the Y-Z plane. The edge DFL of the light guide LGLh is actually a surface inclined at an angle relative to the Y-Z plane.

The edge GVU1h of the light guide LGUAh and the edge GVC1h of the protruding portion LGUCh are referred to as edges, but are actually surfaces parallel to the Y-Z plane, respectively. The edge GVA2h of the light guide LGUAh is referred to as an edge, but is actually a surface inclined at an angle relative to the Y-Z plane. The edge GVC2h of the protruding portion LGUCh and the edge GVD2h of the protruding portion LGUDh are referred to as edges, but are actually surfaces each inclined at an angle relative to the Y-Z plane. The edge DFU of the protruding portion LGUDh is referred to as an edge, but is actually a surface inclined at an angle relative to the Y-Z plane.

The edge GVC2h and the edge GVD2h, formed to be integrated with each other, that is, the edge GVB2h, are referred to as edges, but are actually surfaces inclined at an angle relative to the Y-Z plane. The surface referred to as the edge GVA2h and the surface referred to as the edge GVB2h are inclined at different angles with respect to the Y-Z plane.

In the region between the light guide LGUAh and the light guide LGLh, and where no protruding portion LGUBh is provided, a space exists. The distance between the surface UBS of the light guide LGUAh and the surface LUS of the light guide LGLh in the region where no projecting portion LGUBh is provided (the region where a space exists) is designated as a length dg. Details of the length dg will be described later.

Light LT emitted from the light source element LS1h contains a main light ray ML and diverged light DL. The light LT emitted from the light source element LS1h enters the light guide LGUAh of the light guide LGUh from the edge GVU1h. The width dd of the diverged light DL is equal to the thickness d1 of the light guide LGUuh. The light LT having entered the light guide LGUAuh from the edge GVU1h propagates along the first direction X.

The light LT having reached the edge GVA2h undergoes total internal reflection downward at the edge GVA2h. The light LT undergone total internal reflection at the edge GVA2h reaches the edge GVB2h and undergoes total internal reflection at the edge GVB2h. The light LT undergone total internal reflection at the edge GVB2h exits the light guide LGUh from the edge DFU. The light exiting from the edge DFU enters the interior of the light guide LGLh via the edge DFL of the light guide LGLh.

The light LT having entered the interior of the light guide LGLh further undergoes total internal reflection at the surface LBS of the light guide LGLh. The light totally reflected at the surface LBS propagates in the opposite direction to the first direction X while undergoing total internal reflection repeatedly between the surface LBS and surface LUS within the light guide LGLh. At this time, the condition that the width dd of the diverged light DL is equal to the thickness d1 (dd=d1) is maintained.

When the light LT propagating within light guide LGLh in the direction opposite to the first direction X enters the protruding portion PR, it is reflected at the protruding portion PR and emitted upward. It is then emitted from the surface LUS to the light guide LGUh, and further emitted upward from the surface UUS of the light guide LGUh along the third direction Z.

When the angle A0 at which the light enters the surface LBS of the light guide LGLh is 26.5° (A0=26.5°), the light LT, which contains the diverged light DL, uniformly strikes the region APRh. When it uniformly strikes the region APRh, all of the light LT is emitted upward. That is, the extraction efficiency of the light LT is increased.

The angle at which the main light ray ML of the light LT, having undergone total internal reflection at the edge GVA2h, enters the edge GVB2h is designated as an angle A2. The angle A2 should preferably be 48° or less (A2≤48°). When the light source element LS1h is a laser light source element and the divergence angle dA of the diverged light DL is 6.5°, it is preferable that the angle A2 should be 41.5° or less (A2≤41.5°).

Further, the angle Ab of the edge GVA2h of the light guide LGUAh relative to the first direction X (the angle formed between the edge GVA2h and the surface UUS) as well should preferably be 41.5° or less (Ab≤41.5°).

By setting the angle A2 and the angle Ab to the above-described conditions, the light LT undergoes total internal reflection while maintaining the total internal reflection condition at the edge GVA2h, the edge GVB2h, and the surface LBS.

In a similar manner to FIG. 5, the angle A1 between the main light ray ML and the edge at the surface LBS should preferably be 48° or greater (A1≥48°) in FIG. 7 as well. The angle A1 is, for example, 53° (A1=53°).

The angle between the edge GVB2h and the first direction X, or the angle formed between the surface LBS and the edge GVB2h, is designated as an angle Aa. The angle Aa may be, for example, 68° (Aa=68°).

The distance between the surface UBS of the light guide LGUAh and the surface LUS of the light guide LGLh is designated as a length dg. The total internal reflection angle F is expressed as: F=cos⁻¹ (1/n) (where n is the refractive index). The angle Ab and angle A2 must be less than or equal to the angle F to satisfy total internal reflection.

Here, the divergence angle of the diverged light DL is designated as an angle dA. Considering the divergence angle dA, in order for the diverged light DL to satisfy the total internal reflection condition, it need to be less than or equal to (F−dA). Note here that A2=π−Aa−2Ab (Equation 1), where n is 180° (π=180°).

Between the angle Aa, angle Ab, and angle A0, a relationship of Aa+Ab=(A0+π)/2 (Equation 2) is established.

The length dg is expressed by Equation 3.

$$d g = \frac{\{ tan ( 2 Aa - ( A 0 + dA ) ) + tan ( \frac{A 0 + π}{2} - Aa ) \} tan Aa}{\{ tan ( 2 Aa - ( A 0 + dA ) ) - tan Aa \} tan ( \frac{A 0 + π}{2} - Aa )} d 1 - d 0 \qquad ( Equation 3 )$$

As described above, using (Equation 3), an appropriate gap dg can be obtained based on the angle Aa, the angle A0, the divergence angle dA, the length do, and the length d1.

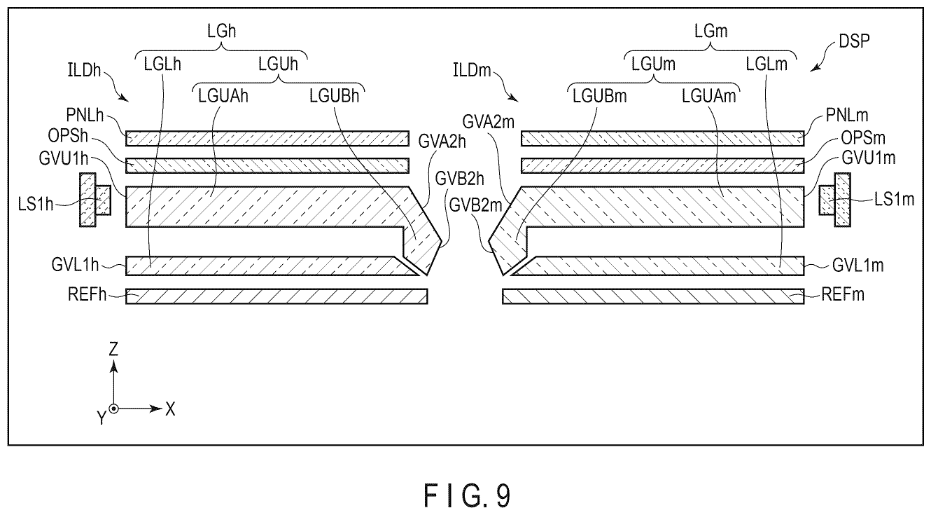

FIG. 9 is a cross-sectional view schematically showing an example of the configuration of the display device of Embodiment 2. On top of the illumination device ILDh, an optical sheet OPSh and a display panel PNLh are provided.

The display device DSP, in a similar manner to that of FIG. 4, comprises an illumination device ILDh, an optical sheet OPSh, and a display panel PNLh, and also an illumination device ILDm, an optical sheet OPSm, and a display panel PNLm arranged in line-symmetry with respect to the second direction Y. Note that the symbols assigned to the components of the illumination device ILDm are derived from the corresponding components of the illumination device ILDh by replacing the last letter of the symbol, that is, “h” with “m”.

In Embodiment 2 as well, it is possible to efficiently extract the light LT emitted from the light source element LS1h.

### <Configuration Example 1 of Embodiment 2>

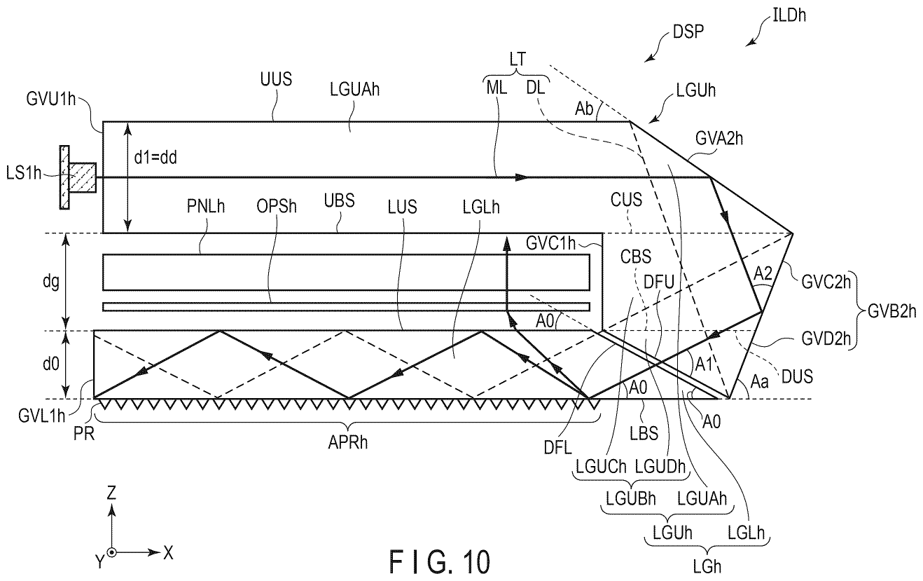

FIG. 10 is a cross-sectional view showing an example of a display device in Embodiment 2. The configuration example shown in FIG. 10 is different as compared to the configuration example shown in FIG. 9 in that the display panel PNLh is provided between the light guide LGUh and the light guide LGLh.

In the display device DSP shown in FIG. 10, an optical sheet OPSh and a display panel PNLh are provided between the surface LUS of the light guide LGLh and the surface UBS of the light guide LGUAh. The optical sheet OPSh and the display panel PNLh are superimposed on the region APRh of the light guide LGLh, where a plurality of protruding portions PR are provided. The length dg between the surface LUS and surface UBS is given by (Equation 3) as described above. If the sum of the thickness of the optical sheet OPSh and the thickness of the display panel PNLh is less than the length dg, the optical sheet OPSh and the display panel PNLh can be provided between the surface LUS of the light guide LGLh and the surface UBS of the light guide LGUh.

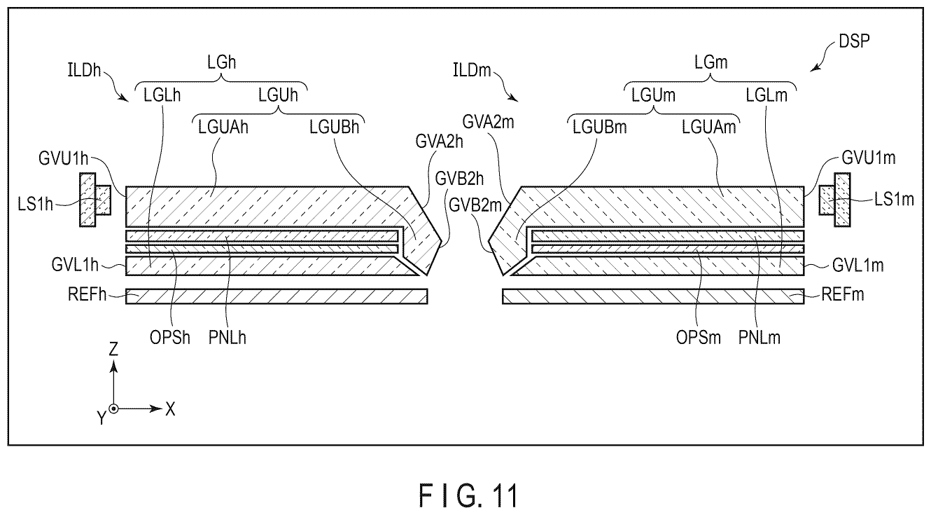

FIG. 11 is a cross-sectional view schematically showing another example of the configuration of the display device of Embodiment 2. The display device DSP, in a similar manner to those of FIGS. 4 and 9, comprises an illumination device ILDh, an optical sheet OPSh, and a display panel PNLh, and also an illumination device ILDm, an optical sheet OPSm, and a display panel PNLm arranged in line-symmetry with respect to the second direction Y. Note that the symbols assigned to the components of the illumination device ILDm are derived from the corresponding components of the illumination device ILDh by replacing the last letter of the symbol, that is, “h” with “m”.

When the optical sheet OPSh and the display panel PNLh are placed between the light guide LGUh and the light guide LGLh, and the optical sheet OPSm and the display panel PNLm are placed between the light guide LGUm and the light guide LGLm, the thickness of the display device DSP can be reduced.

In Configuration Example 1 as well, advantageous effects similar to those of Embodiment 2 can be achieved.

### Embodiment 3

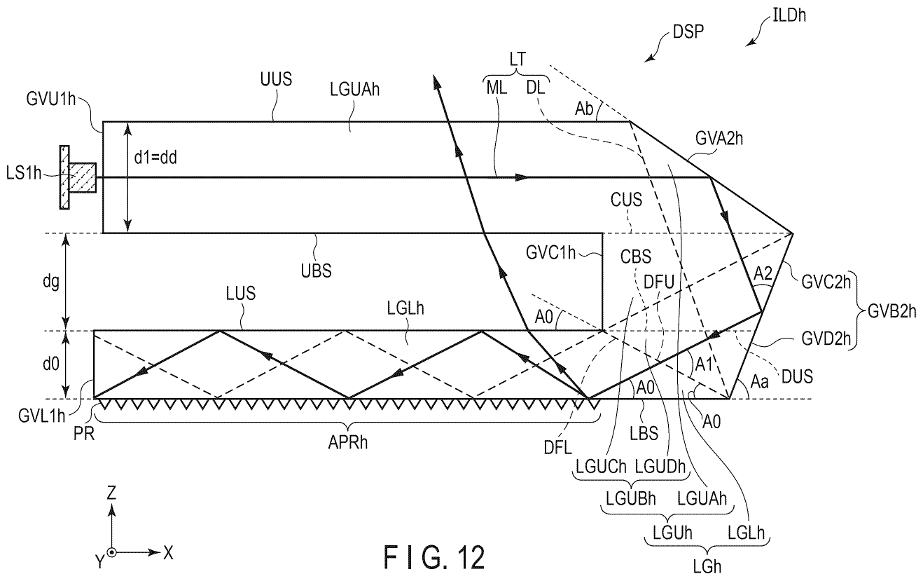

FIG. 12 is a cross-sectional view showing an example of an illumination device in Embodiment 3. The configuration example shown in FIG. 12 is different from the configuration example shown in FIG. 7 in that the illumination device has a single light guide formed to be integrated therewith.

The illumination device ILDh shown in FIG. 12 has a light guide LGh having an approximately U-shaped configuration, or a shape of an alphabet U laid on its side. The light guide LGh includes a light guide LGUh and a light guide LGLh, which are formed to be integrated therewith. The light guide LGUh comprises a light guide LGUAh and a protruding portion LGUBh, which are formed to be integrated therewith. The protruding portion LGUBh comprises a protruding portion LGUCh and a protruding portion LGUDh, which are formed to be integrated therewith.

The cross-sectional shape of the light guide LGh shown in FIG. 12 is different from that of the light guide LGh shown in FIG. 7 in that the light guide LGUh (the light guide LGUAh and protruding portion LGUBh) and the light guide LGLh are formed to be integrated with each other. The edge DFU of the protruding portion LGUDh of the light guide LGUh and the edge DFL of the light guide LGLh, shown in FIG. 12, are in contact with each other. Or, it can be said that the edge DFU and edge DFL are the same as each other.

The shapes of the light guide LGUAh, the protruding portion LGUCh, and the protruding portion LGUDh shown in FIG. 12, is the same as those in FIG. 7, respectively. As described above, in the light guide LGh shown in FIG. 12, the light guide LGUAh, the protruding portion LGUCh, the protruding portion LGUDh, and the light guide LGLh are formed to be integrated with each other.

In a similar manner to that of FIG. 7, the oblique edge GVC2h of the protruding portion LGUCh is integrated with the edge GVD2h of the protruding portion LGUDh to form a single edge GVB2h. The edge GVB2h is an oblique edge sloping downward to the left relative to the page.

The edge GVA2h and the edge GVB2h form a U-shaped edge. In other words, the edge GVA2h and the edge GVB2h form a mountain-like shape turned on its side. Or, the edge GVA2h and the edge GVB2h constitute a shape similar with a greater-than sign of “>”.

A space exists in the region between the light guide LGUAh and the light guide LGLh and where no protruding portion LGUBh is provided. The length dg, which is the distance between the surface UBS of the light guide LGUh and the surface LUS of the light guide LGLh in the region where the protruding portion LGUBh is not provided (the region where space exists), satisfies (Equation 3) described in Embodiment 2.

The manner in which the light LT emitted from the light source element LS1h propagates within the light guide LGh is substantially similar to that in Embodiment 2. But note that, in Embodiment 2, the light LT is emitted from the edge DFU of the protruding portion LGUDh of the light guide LGUh. The thus emitted light LT enters the interior of the light guide LGLh from its edge DFL. That is, in Embodiment 2, the light LT is once emitted to the outside of the light guide LGUh and the light guide LGLh. By contrast, in Embodiment 3, the light guide LGh is integrally formed. With this configuration, the light LT propagating from the edge DFU of the protruding portion LGUDh to the edge DFL of the light guide LGLh goes through the inside of the light guide LGH. Therefore, in Embodiment 3, the light LT can be propagated more efficiently, and the light LT can be extracted even more efficiently.

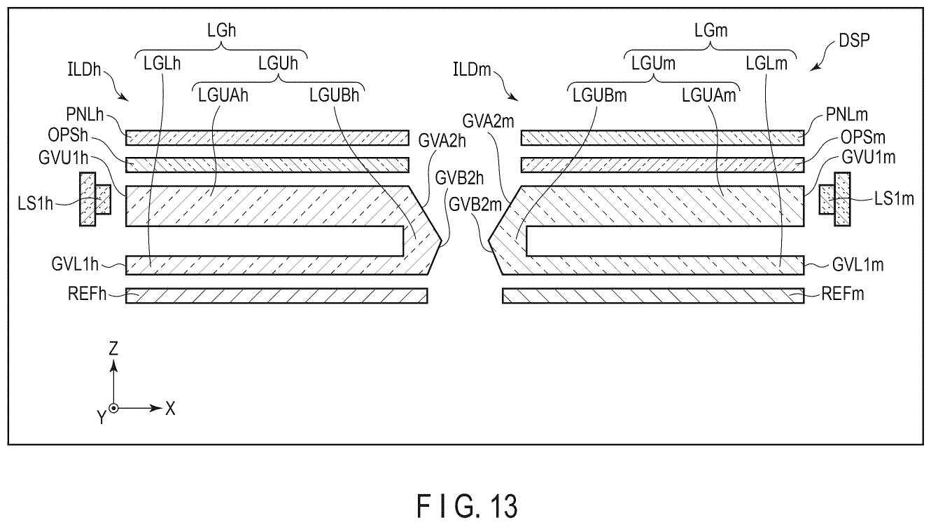

FIG. 13 is a cross-sectional view schematically showing another example of the configuration of the display device of Embodiment 3. An optical sheet OPSh and a display panel PNLh are provided on top of the illumination device ILDh.

The display device DSP, in a similar manner to those of FIGS. 4 and 9, comprises an illumination device ILDh, an optical sheet OPSh, and a display panel PNLh, and also an illumination device ILDm, an optical sheet OPSm, and a display panel PNLm arranged in line-symmetry with respect to the second direction Y. Note that the symbols assigned to the components of the illumination device ILDm are derived from the corresponding components of the illumination device ILDh by replacing the last letter of the symbol, that is, “h” with “m”.

In Embodiment 3 as well, the light LT emitted from the light source element LS1h can be efficiently extracted.

### <Configuration Example 1 of Embodiment 3>

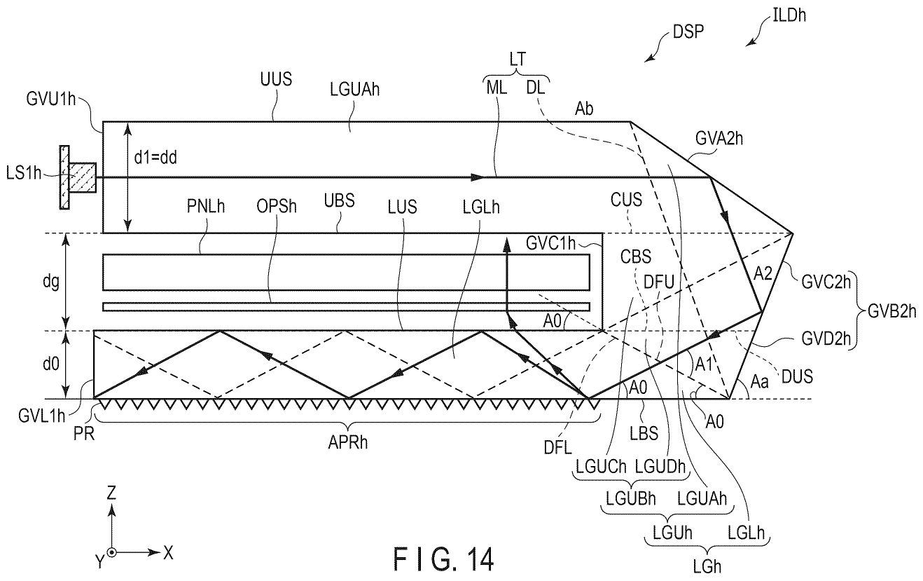

FIG. 14 is a cross-sectional view showing an example of the display device in Embodiment 3. The configuration example shown in FIG. 14 is different from the configuration example shown in FIG. 12 in that the display panel PNLh is provided between the light guide LGUh and the light guide LGLh.

In the display device DSP shown in FIG. 14, an optical sheet OPSh and a display panel PNLh are provided between the surface LUS of the light guide LGLh and the surface UBS of the light guide LGUh. The optical sheet OPSh and the display panel PNLh are superimposed on the region APRh of the light guide LGLh, where multiple protruding portions PR are provided. The length dg between the surface LUS and surface UBS is given by (Equation 3) as described above. If the sum of the thickness of the optical sheet OPSh and the thickness of the display panel PNLh is less than the length dg, the optical sheet OPSh and the display panel PNLh can be provided between the surface LUS of the light guide LGLh and the surface UBS of the light guide LGUh.

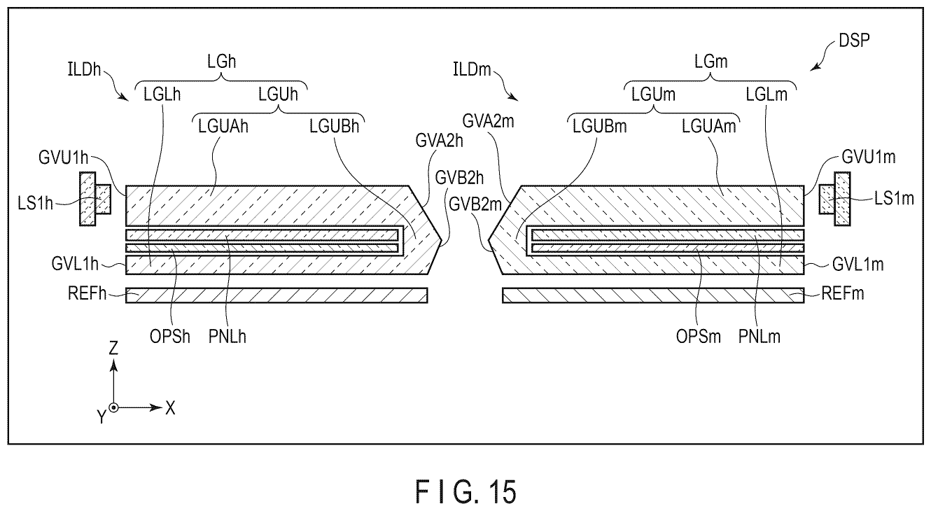

FIG. 15 is a cross-sectional view schematically showing another example of the configuration of the display device of Embodiment 2. The display device DSP, in a similar manner to that of FIG. 4, comprises an illumination device ILDh, an optical sheet OPSh, and a display panel PNLh, and also an illumination device ILDm, an optical sheet OPSm, and a display panel PNLm arranged in line-symmetry with respect to the second direction Y. Note that the symbols assigned to the components of the illumination device ILDm are derived from the corresponding components of the illumination device ILDh by replacing the last letter of the symbol, that is, “h” with “m”.

By providing the optical sheet OPSh and display panel PNLh between the light guide LGUh and the light guide LGLh, and the providing the optical sheet OPSm and the display panel PNLm between the light guide LGUm and the light guide LGLm, the thickness of the display device DSP can be reduced.

In Configuration Example 1 as well, advantageous effects similar to those of Embodiment 2 can be achieved.

In this disclosure, it is possible to obtain an illumination device with improved light extraction efficiency. Further, by incorporating such an illumination device, it is possible to obtain a display device with enhanced brightness.

In this disclosure, the light guide LGLh and the light guide LGUh can as well be referred to as a first light guide and a second light guide, respectively. The light guide LGUAh of the light guide LGUh may as well be referred to as a third light guide.

In this disclosure, the surface LBS and the surface LUS of the light guide LGLh may as well be referred to as a first surface and a second surface, respectively. The surface UBS and the surface UUS of the light guide LGUAh may as well be referred to as a third surface and a fourth surface, respectively. The thickness do of the light guide LGLh may as well be referred to as a first thickness, and the thickness d1 of the light guide LGUAh may as well be referred to as a second thickness. In this disclosure, the third direction Z may as well be referred to as a thickness direction.

In this disclosure, the region APRh of the surface LBS of the light guide LGLh, where multiple protruding portions PR are provided, may as well be referred to as a first region.

In FIG. 5, the edge GVL1h and the edge DFL of the light guide LGLh may as well be referred to as a first edge and a second edge, respectively. The edge GVU1h and the edge GVA2Ah of the light guide LGUAh may as well be referred to as a third edge and a fourth edge, respectively. The edge DFU of the protruding portion LGUBh may as well be referred to as a fifth edge, and the edge GVB2h may as well be referred to as a sixth edge. The edge GVU2h, constituted by the edge GVA2h of the light guide LGUAh and the edge GVB2h of the protruding portion LGUBh formed to be integrated with each other, may as well be referred to as a seventh edge.

In FIG. 5, when the main light ray ML of the light LT reflected by the mirror MRRh enters the light guide LGLh from its surface LBS, the angle A0 formed between the main light ray ML and surface LBS may as well be referred to as a first angle.

In FIG. 5, the protruding portion LGUBh may as well be referred to as a first protruding portion. The protruding portion PR may as well be referred to as a second protruding portion.

In FIG. 7, the protruding portion LGUBh may as well be referred to as a first protruding portion. The protruding portion LGUCh may as well be referred to as a second protruding portion, and the protruding portion LGUDh may as well be referred to as a third protruding portion. The protruding portion PR may as well be referred to as a fourth protruding portion.

In FIG. 7, the surface CUS and surface CBS of the protruding portion LGUCh may as well be referred to as a fifth surface and a sixth surface, respectively.

In FIG. 7, the edge GVL1h and the edge DFL of the light guide LGLh may as well be referred to as a first edge and a second edge, respectively. The edge GVU1h and the edge GVA2h of the light guide LGUAh may as well be referred to as a third edge and a fourth edge, respectively. The edge DFU and the edge GVC2h of the protruding portion LGUCh may as well be referred to as a fifth edge and a sixth edge, respectively. The edge DFU and the edge GVD2h of the protruding portion LGUDh may as well be referred to as a seventh edge and an eighth edge, respectively. The edge GVB2h, constituted by the edge GVC2h of the protruding portion LGUCh and the edge GVD2h of the protruding portion LGUDh formed to be integrated with each other, may as well be referred to as a ninth edge.

In FIG. 7, when the main light ray ML of light LT reflected by the mirror MRRh enters the light guide LGLh from its surface LBS, the angle A0 formed by the main light ray ML and the surface LBS may as well be referred to as a first angle.

In FIG. 12, the ordinal numbers for the light guides, protruding portions, surfaces, edges, and angles are similar to those of FIG. 7.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An illumination device comprising:
a first light guide having a first edge and a second edge provided on an opposite side to the first edge, a first surface and a second surface provided on an opposite side to the first surface;
a second light guide provided on the first light guide;
a light source element provided to face the second light guide;
a reflector provided to face the first surface of the first light guide; and
an optical sheet provided on the second light guide,
wherein
the first light guide has a cross-sectional shape of a first trapezoid in which a lower base thereof is longer than an upper base,
the second light guide includes a third light guide and a first protruding portion formed to be integrated with each other,
the third light guide has a cross-sectional shape of a second trapezoid in which a lower base thereof is longer than an upper base,
the first protruding portion has a cross-sectional shape of a third trapezoid in which an upper base thereof is longer than a lower base,
the third light guide has a third edge and a fourth edge provided on an opposite side to the third edge, a third surface and a fourth surface provided on an opposite side to the third surface,
the first protruding portion has a fifth edge parallel to the second edge and a sixth edge provided on an opposite side to the fifth edge,
the second surface of the first light guide and the third surface of the third light guide face each other,
a plurality of second protruding portions are provided in a first region of the first surface of the first light guide,
the fourth edge of the second light guide and the sixth edge of the first protruding portion are formed to be integrated to constitute a seventh edge,
the seventh edge is inclined relative to a thickness direction, and
a reflecting member is provided in contact with the seventh edge.

2. The illumination device according to claim 1, wherein
light emitted from the light source element contains a main light ray and diverged light,
the light emitted from the light source element enters the third light guide from the third edge thereof,
the light entering from the third edge is reflected downward by the reflecting member provided in contact with the seventh edge,
the light reflected by the reflecting member is emitted from the fifth edge of the first protruding portion and enters the first light guide from the second edge thereof,
the light entering from the second edge is reflected by the first surface,
the light reflected by the first surface is reflected by the second surface,
the light entering the plurality of second protruding portions provided in the first region of the first surface is emitted upward by the plurality of second protruding portions, and
a first angle is formed between the main light ray of the light entering the first light guide from the first surface and the first surface itself, which is 26.5°.

3. The illumination device according to claim 1, wherein
when the first light guide has a first thickness, and the third light guide has a second thickness, the second thickness is 1.8 times or more the first thickness.

4. The illumination device according to claim 1, wherein
the reflecting member is a mirror.

5. The illumination device according to claim 1, wherein
the reflecting member is a support member having a mirror-finished surface.

6. A display device comprising:
the illumination device according to claim 1; and
a display panel provided on the illumination device.

7. An illumination device comprising:
a first light guide having a first edge and a second edge provided on an opposite side to the first edge, a first surface and a second surface provided on an opposite side to the first surface;
a second light guide provided on the first light guide;
a light source element provided to face the second light guide; and
a reflector provided to face the first surface of the first light guide,
wherein
the first light guide has a cross-sectional shape of a first trapezoid in which a lower base thereof is longer than an upper base,
the second light guide includes a third light guide and a first protruding portion formed to be integrated with each other,
the third light guide has a cross-sectional shape of a second trapezoid in which a lower base thereof is longer than an upper base,
the third light guide has a third surface and a fourth surface provided on an opposite side to the third surface, a third edge and a fourth edge provided on an opposite side to the third edge,
the first protruding portion includes a second protruding portion and a third protruding portion formed to be integrated with each other,
the second protruding portion has a cross-sectional shape of a third trapezoid in which an upper base thereof is longer than a lower base,
the second protruding portion has a fifth edge parallel to the third and a sixth edge provided on an opposite side to the fifth edge,
the third protruding portion has a cross-sectional shape of a triangle,
the third protruding portion has a seventh edge parallel to the second edge and an eighth edge distinct from the seventh edge,
the sixth edge of the second protruding portion and the eighth edge of the third protruding portion are formed to be integrated to constitute a ninth edge,
the light source element is provided to face the third edge of the third light guide,
the second surface of the first light guide and the third surface of the third light guide face each other,
a plurality of fourth projecting portions are provided in a first region of the first surface of the first light guide, and
the fourth edge and the ninth edge form a U-shaped edge.

8. The illumination device according to claim 7, wherein
light emitted from the light source element contains a main light ray and diverged light,
the light emitted from the light source element enters the third light guide from the third edge thereof,
the light entering from the third edge is reflected downward by total internal reflection at the fourth edge,
the light reflected downward by total internal reflection at the fourth edge is reflected downward by total internal reflection at the ninth edge,
the light reflected downward by total internal reflection at the ninth edge is emitted from the seventh edge of the first protruding portion and enters the first light guide from the second edge thereof,
the light entering from the second edge is reflected by the first surface,
the light entering from the first surface is reflected by the first surface,
the light reflected by the first surface is reflected by the second surface,
the light entering the plurality of fourth protruding portions provided in the first region of the first surface is emitted upward by the plurality of fourth protruding portions, and
a first angle is formed between the main light ray of the light entering the first light guide from the first surface and the first surface itself, which is 26.5°.

9. The illumination device according to claim 7, wherein
when the first light guide has a first thickness, and the third light guide has a second thickness, the second thickness is 1.8 times or more the first thickness.

10. A display device comprising:
the illumination device according to claim 7;
an optical sheet provided on the illumination device; and
a display panel provided on the optical sheet.

11. A display device comprising:
the illumination device according to claim 7;
an optical sheet provided between the first light guide and the third light guide and overlaid on the first region; and
a display panel provided between the first light guide and the third light guide and overlaid on the first region,
wherein
the display panel is provided between the optical sheet and the third light guide.

12. An illumination device comprising:
a light guide including a first light guide and a second light guide formed to be integrated with each other;
a light source element provided to face the second light guide; and
a reflector provided to face the first light guide,
wherein
the first light guide has a first edge and a second edge provided on an opposite side to the first edge, and a first surface and a second surface provided on an opposite side to the first surface,
the first light guide has a cross-sectional shape of a first trapezoid in which a lower base thereof is longer than an upper base,
the second light guide is provided on the first light guide,
the second light guide includes a third light guide and a first protruding portion formed to be integrated with each other,
the third light guide has a cross-sectional shape of a second trapezoid in which a lower base thereof is longer than an upper base,
the third light guide has a third surface and a fourth surface provided on an opposite side to the third surface, and a third edge and a fourth edge provided on an opposite side to the third edge,
the first protruding portion includes a second protruding portion and a third protruding portion formed to be integrated with each other,
the second protruding portion has a cross-sectional shape of a third trapezoid in which an upper base thereof is longer than a lower base,
the second protruding portion has a fifth edge parallel to the third and a sixth edge provided on an opposite side to the fifth edge,
the third protruding portion has a cross-sectional shape of a triangle,
the third protruding portion has a seventh edge parallel to the second edge and an eighth edge distinct from the seventh edge,
the sixth edge of the second protruding portion and the eighth edge of the third protruding portion are formed to be integrated to constitute a ninth edge,
the light source element is provided to face the third edge of the third light guide,
the reflector is provided to face the first surface of the first light guide,
the second surface of the first light guide and the third surface of the third light guide face each other,
a plurality of fourth projecting portions are provided in a first region of the first surface of the first light guide, and
the fourth edge and the ninth edge form a U-shaped edge.

13. The illumination device according to claim 12, wherein
light emitted from the light source element contains a main light ray and diverged light,
the light emitted from the light source element enters the third light guide from the third edge thereof,
the light entering from the third edge is reflected downward by total internal reflection at the fourth edge,
the light reflected downward by total internal reflection at the fourth edge is reflected downward by total internal reflection at the ninth edge,
the light reflected downward by total internal reflection at the ninth edge propagates from the seventh edge of the first protruding portion to the second edge of the first light guide,
the light entering from the second edge is reflected by the first surface,
the light entering from the first surface is reflected by the first surface,
the light reflected by the first surface is reflected by the second surface,
the light entering the plurality of fourth protruding portions provided in the first region of the first surface is emitted upward by the plurality of fourth protruding portions, and
a first angle is formed between the main light ray of the light entering the first light guide from the first surface and the first surface itself, which is 26.5°.

14. The illumination device according to claim 12, wherein
when the first light guide has a first thickness, and the third light guide has a second thickness, the second thickness is 1.8 times or more the first thickness.

15. A display device comprising:
the illumination device according to claim 12;
an optical sheet provided on the illumination device; and
a display panel provided on the optical sheet.

16. A display device comprising:
the illumination device according to claim 12;
an optical sheet provided between the first light guide and the third light guide and overlaid on the first region; and
a display panel provided between the first light guide and the third light guide and overlaid on the first region,
wherein
the display panel is provided between the optical sheet and the third light guide.
